(19) United States
(12) Patent Application Publication
(10) Pub. No.: US 2022/0222962 A1
(43) Pub. Date: Jul. 14, 2022

(54) COMPUTING DEVICE, COMPUTING METHOD, AND COMPUTING PROGRAM

(71) Applicant: NTT Communications Corporation, Tokyo (JP)

(72) Inventors: Ryosuke TANNO, Tokyo (JP); Syuhei ASANO, Funabashi-shi (JP); Kazuki KOYAMA, Tokyo (JP)

(73) Assignee: NTT Communications Corporation, Tokyo (JP)

(21) Appl. No.: 17/709,418

(22) Filed: Mar. 31, 2022

Related U.S. Application Data
(63) Continuation of application No. PCT/JP2020/037554, filed on Oct. 2, 2020.

(30) Foreign Application Priority Data
Oct. 4, 2019 (JP) 2019-183966

(51) Int. Cl. G06V 40/10; G06V 10/74

(52) U.S. Cl. CPC G06V 40/103; G06V 10/761

(57) ABSTRACT

A computing device uses image data as an input, and estimates skeleton data by using a skeleton estimation model for estimating the skeleton data related to a skeleton of a person. The computing device then calculates weight values of respective articulations based on reliability of estimation results of the respective articulations, and computes a similarity between pieces of the skeleton data by using the calculated weight values of the respective articulations. The computing device then determines whether the similarity is equal to or larger than a predetermined threshold. If the similarity is equal to or larger than the predetermined threshold, the computing device determines that authentication has succeeded, and if the similarity is smaller than the predetermined threshold, the computing device determines that authentication has failed.

### CROSS-REFERENCE TO RELATED APPLICATIONS

This application is a continuation of PCT International Application No. PCT/JP2020/037554 filed on Oct. 2, 2020 which claims the benefit of priority from Japanese Patent Application No. 2019-183966 filed on Oct. 4, 2019, the entire contents of which are incorporated herein by reference.

### FIELD

The present invention relates to a computing device, a computing method, and a computing program.

### BACKGROUND

In recent years, there is known a technique of performing personal authentication by using various kinds of biometric authentication. As such an authentication technique, for example, there is known a technique of estimating a posture of a person by estimating articulation positions of the person from image data including the whole body of the person as an authentication target, and performing personal authentication based on a similarity between the estimated posture and a posture registered in advance. The related technologies are described, for example, in: Japanese Patent Application Laid-open No. 2018-013999.

However, the conventional method of personal authentication has the problem that accuracy of authentication processing may be lowered in some cases. For example, there is a part of articulation that is difficult to be estimated depending on an image, so that the conventional method of personal authentication has the problem that reliability of an estimation result varies depending on each part of articulation, and accuracy of authentication is lowered.

### SUMMARY

It is an object of the present invention to at least partially solve the problems in the conventional technology.

According to an aspect of the embodiments, a computing device includes: processing circuitry configured to: acquire image data including a person; estimate skeleton data by using the image data acquired as an input, and using a skeleton estimation model for estimating the skeleton data related to a skeleton of the person; calculate weight values of respective articulations based on reliability of estimation results of the respective articulations; and compute a similarity between the skeleton data estimated and skeleton data estimated from predetermined image data by using the weight values of the respective articulations calculated.

The above and other objects, features, advantages and technical and industrial significance of this invention will be better understood by reading the following detailed description of presently preferred embodiments of the invention, when considered in connection with the accompanying drawings.

### BRIEF DESCRIPTION OF DRAWINGS

FIG. 1 is a block diagram illustrating a configuration example of a computing device according to a first embodiment;

FIG. 2 is a diagram for explaining processing of computing a similarity of a skeleton;

FIG. 3 is a diagram for explaining an outline of authentication processing performed by the computing device according to the first embodiment;

FIG. 4 is a flowchart illustrating an example of a procedure of processing performed by the computing device according to the first embodiment;

FIG. 5 is a diagram for explaining an outline of authentication processing performed by a computing device according to a second embodiment;

FIG. 6 is a diagram for explaining variation in estimated positions of articulations; and

FIG. 7 is a diagram illustrating a computer that executes a computing program.

### DESCRIPTION OF EMBODIMENT(S)

The following describes embodiments of a computing device, a computing method, and a computing program according to the present application in detail based on the drawings. The computing device, the computing method, and the computing program according to the present application are not limited to the embodiments.

### First Embodiment

The following embodiment describes a configuration of a computing device 10 according to a first embodiment and a procedure of processing performed by the computing device 10 in order, and lastly describes an effect of the first embodiment.

Configuration of Computing Device

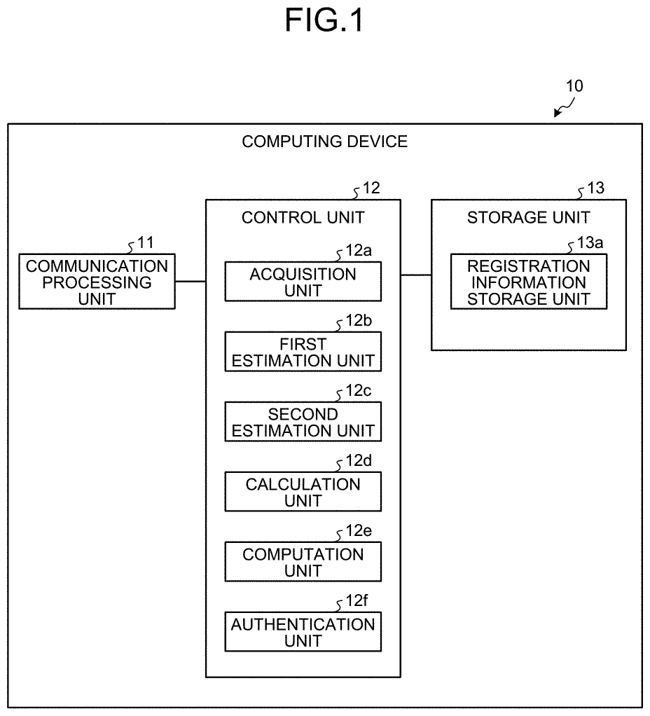

First, the following describes the configuration of the computing device 10 with reference to FIG. 1. FIG. 1 is a block diagram illustrating a configuration example of the computing device according to the first embodiment. The computing device 10 is a device that estimates skeleton data of a person by acquiring image data of the person as an authentication target to perform personal authentication, and performs personal authentication by computing a similarity between the estimated skeleton data and skeleton data as a correct answer.

Specifically, the computing device 10 uses the image data as an input, and estimates the skeleton data by using a skeleton estimation model for estimating the skeleton data related to a skeleton of the person. The computing device 10 also uses image data stored in advance in a storage unit 13 as an input, and estimates the skeleton data by using the skeleton estimation model.

The computing device 10 then calculates weight values of respective articulations based on reliability of estimation results of the articulations in the estimated skeleton data, and computes a similarity between pieces of the skeleton data by using the calculated weight values of the respective articulations. The computing device 10 then determines whether the similarity is equal to or larger than a predetermined threshold. If the similarity is equal to or larger than the predetermined threshold, the computing device 10 determines that authentication has succeeded, and if the similarity is smaller than the predetermined threshold, the computing device 10 determines that authentication has failed.

As illustrated in FIG. 1, the computing device 10 includes a communication processing unit 11, a control unit 12, and the storage unit 13. The following describes processing performed by each unit included in the computing device 10.

The communication processing unit 11 controls communication related to various kinds of information exchanged with a connected device. For example, the communication processing unit 11 receives image data as a processing target of skeleton estimation from an external device. The storage unit 13 stores data and computer programs necessary for various kinds of processing performed by the control unit 12 and includes a registration information storage unit 13a. For example, the storage unit 13 is a storage device such as a semiconductor memory element including a random access memory (RAM), a flash memory, and the like.

The registration information storage unit 13a stores an image of the whole body registered in advance by a user. For example, the registration information storage unit 13a stores, as the image of the whole body, an image of the whole body of the user in a state in which the user makes a predetermined pose (for example, raising both hands) in front of a camera. This pose may be freely determined by the user at the time of registration, or may be a pose that is determined in advance and notified to only an authorized user. The data stored in advance in the registration information storage unit 13a is not necessarily an image, but may be an estimation result of a skeleton estimated from predetermined image data or reliability of the respective articulations. That is, the registration information storage unit 13a may store an estimation result of the skeleton that is estimated from the image of the whole body of the user in a state of making a predetermined pose by using the skeleton estimation model, or reliability of the respective articulations output from the skeleton estimation model in advance.

The control unit 12 includes an internal memory for storing required data and computer programs specifying various processing procedures and executes various kinds of processing therewith. For example, the control unit 12 includes an acquisition unit 12a, a first estimation unit 12b, a second estimation unit 12c, a calculation unit 12d, a computation unit 12e, and an authentication unit 12f. Herein, the control unit 12 is, for example, an electronic circuit such as a central processing unit (CPU), a micro processing unit (MPU), and a graphical processing unit (GPU), or an integrated circuit such as an application specific integrated circuit (ASIC) and a field programmable gate array (FPGA).

The acquisition unit 12a acquires image data including a person. For example, the acquisition unit 12a acquires image data from a camera by which the whole body of the person as the authentication target is photographed, and outputs the image data to the first estimation unit 12b.

The first estimation unit 12b uses the image data acquired by the acquisition unit 12a as an input, and estimates the skeleton data by using the skeleton estimation model for estimating the skeleton data related to the skeleton of the person. For example, the first estimation unit 12b specifies positions of respective parts of the skeleton of the person in the image data by inputting the image data to the skeleton estimation model, and estimates positions of a “right shoulder”, a “right upper arm”, a “right forearm”, a “left shoulder”, a “left upper arm”, a “left forearm”, a “right thigh”, a “right crus”, a “left thigh”, and a “left crus” as portions corresponding to respective articulations.

The second estimation unit 12c uses the image data stored in advance in the registration information storage unit 13a as an input, and estimates the skeleton data by using the skeleton estimation model. For example, the second estimation unit 12c reads out the image data stored in the registration information storage unit 13a, specifies positions of respective parts of the skeleton of the person in the image data by inputting the read-out image data to the skeleton estimation model, and estimates positions of the “right shoulder”, the “right upper arm”, the “right forearm”, the “left shoulder”, the “left upper arm”, the “left forearm”, the “right thigh”, the “right crus”, the “left thigh”, and the “left crus” as portions corresponding to the respective articulations.

The calculation unit 12d calculates weight values of the respective articulations based on the reliability of estimation results of the respective articulations. Specifically, the calculation unit 12d calculates the weight values of the respective articulations based on the reliability of the estimation results of the respective articulations in the skeleton data estimated by the first estimation unit 12b and the skeleton data estimated by the second estimation unit 12c. For example, the calculation unit 12d calculates the weight values of the respective articulations based on the reliability of the estimation results of the respective articulations output from the skeleton estimation model. In a case in which the reliability of the estimation results of the respective articulations are stored in advance in the registration information storage unit 13a, the calculation unit 12d may read out the reliability from the registration information storage unit 13a, and calculate the weight values of the respective articulations based on the read-out reliability.

The following describes a specific example of calculation processing for the weight values of the respective articulations. For example, the calculation unit 12d calculates, for each of the articulations, an average of the reliability of the estimation results of the respective articulations output from the skeleton estimation model at the time when the first estimation unit 12b performs skeleton estimation and the reliability of the estimation results of the respective articulations output from the skeleton estimation model at the time when the second estimation unit 12c performs skeleton estimation by using the following expression (1), and calculates the weight values of the respective articulations. In the following expression, it is assumed that J represents a set of articulations, j represents a certain articulation, θ represents an angle of the articulation j, and conf represents the reliability. Hereinafter, the skeleton data estimated by the first estimation unit 12b is referred to as “skeleton data A”, and the skeleton data estimated by the second estimation unit 12c is referred to as “skeleton data B” as appropriate.

aⱼ=mean(conf_{j,A},conf_{j,B}) (1)

The computation unit 12e computes the similarity between the skeleton data estimated by the first estimation unit 12b and skeleton data estimated from predetermined image data by using the weight values of the respective articulations calculated by the calculation unit 12d. Specifically, the computation unit 12e computes the similarity between the skeleton data estimated by the first estimation unit 12b and the skeleton data estimated by the second estimation unit 12c by using the weight values of the respective articulations calculated by the calculation unit 12d. In a case in which a result of estimating the skeleton is stored in advance in the registration information storage unit 13a, the computation unit 12e may read out the result of estimating the skeleton from the registration information storage unit 13a, and compute the similarity between the read-out result of estimating the skeleton and the skeleton data estimated by the first estimation unit 12b.

The following describes a specific example of computation processing for the similarity. For example, as represented by the following expression (2), the computation unit 12e obtains similarities for all of the articulations, and computes, as a similarity score of the skeleton of the user, a total value of values obtained by assigning weights of the respective articulations to the similarities of the respective articulations.

Score_{similarity}=Σⱼ^{J}aⱼsim(θ_{j,A},θ_{j,B}) (2)

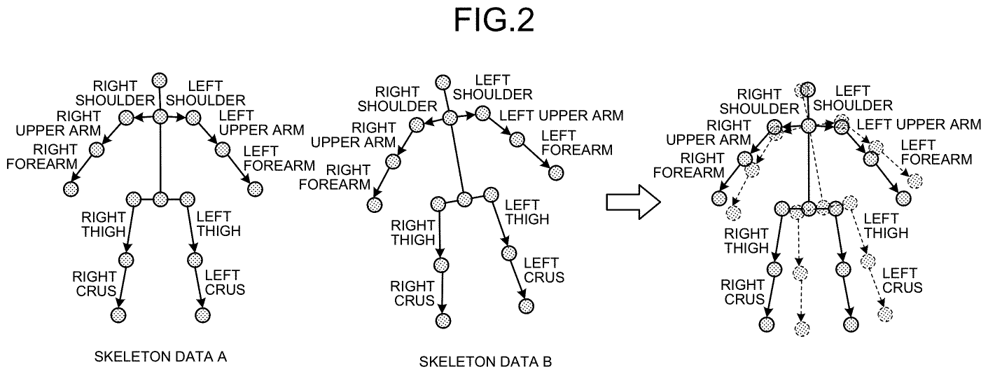

The following describes processing of computing the similarity of the skeleton with reference to FIG. 2. FIG. 2 is a diagram for explaining the processing of computing the similarity of the skeleton. As exemplified in FIG. 2, the computation unit 12e specifies positions of respective parts of the skeleton from a whole body image for each of the skeleton data A estimated by the first estimation unit 12b and the skeleton data B estimated by the second estimation unit 12c, and specifies angles of the “right shoulder”, the “right upper arm”, the “right forearm”, the “left shoulder”, the “left upper arm”, the “left forearm”, the “right thigh”, the “right crus”, the “left thigh”, and the “left crus” as respective articulations. For example, the computation unit 12e computes closeness between angles of vectors as a similarity using a cosine similarity. In this case, a value becomes closer to 1 as angles of two vectors become closer to each other.

The authentication unit 12f determines whether the similarity computed by the computation unit 12e is equal to or larger than a predetermined threshold. If the similarity is equal to or larger than the predetermined threshold, the authentication unit 12f determines that authentication has succeeded, and if the similarity is smaller than the predetermined threshold, the authentication unit 12f determines that authentication has failed.

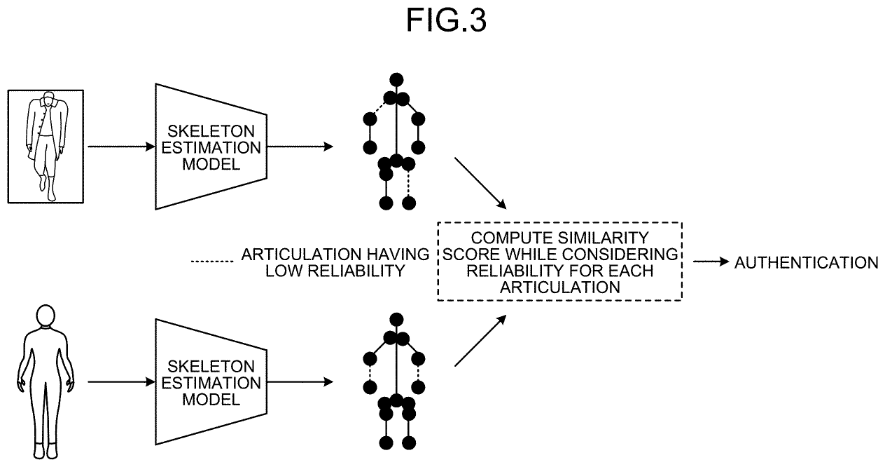

Herein, the following describes an outline of authentication processing performed by the computing device 10 with reference to FIG. 3. FIG. 3 is a diagram for explaining the outline of the authentication processing performed by the computing device. As exemplified in FIG. 3, the computing device 10 inputs the acquired image data to the skeleton estimation model to estimate the skeleton data, and inputs the image data registered in advance to the skeleton estimation model to estimate the skeleton data. Herein, the computing device 10 also acquires the reliability of the respective articulations output from the skeleton estimation model.

The computing device 10 then computes the similarity score for the two pieces of estimated skeleton data while considering the reliability for each of the articulations. Thereafter, the computing device 10 determines whether the computed similarity is equal to or larger than the predetermined threshold. If the similarity is equal to or larger than the predetermined threshold, the computing device 10 determines that authentication has succeeded, and if the similarity is smaller than the predetermined threshold, the computing device 10 determines that authentication has failed. The computing device 10 may perform processing up to the computation processing for the similarity score, and the authentication processing may be performed by another device.

Processing Procedure of Computing Device

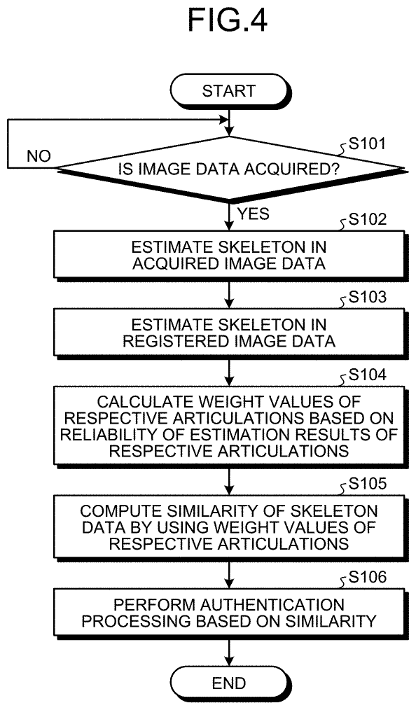

Next, the following describes an example of a processing procedure performed by the computing device 10 according to the first embodiment with reference to FIG. 4. FIG. 4 is a flowchart illustrating an example of a procedure of processing performed by the computing device according to the first embodiment.

As exemplified in FIG. 4, in the computing device 10, if the acquisition unit 12a acquires the image data including the whole body of the person (Yes at Step S101), the first estimation unit 12b uses the image data acquired by the acquisition unit 12a as an input, and estimates the skeleton data by using the skeleton estimation model for estimating the skeleton data related to the skeleton of the person (Step S102).

The second estimation unit 12c then uses the image data registered in advance in the registration information storage unit 13a as an input, and estimates the skeleton data by using the skeleton estimation model (Step S103). This processing can be omitted in a case in which the result of estimating the skeleton is stored in advance in the registration information storage unit 13a. Subsequently, the calculation unit 12d calculates the weight values of the respective articulations based on the reliability of the estimation results of the respective articulations in the skeleton data estimated by the first estimation unit 12b and the skeleton data estimated by the second estimation unit 12c (Step S104).

The computation unit 12e then computes the similarity between the skeleton data estimated by the first estimation unit 12b and the skeleton data estimated by the second estimation unit 12c by using the calculated weight values of the respective articulations (Step S105).

Thereafter, the authentication unit 12f determines whether the similarity computed by the computation unit 12e is equal to or larger than the predetermined threshold. If the similarity is equal to or larger than the predetermined threshold, the authentication unit 12f determines that authentication has succeeded, and if the similarity is smaller than the predetermined threshold, the authentication unit 12f determines that authentication has failed (Step S106).

Effect of First Embodiment

The computing device 10 according to the first embodiment uses the image data as an input, and estimates the skeleton data by using the skeleton estimation model for estimating the skeleton data related to the skeleton of the person. The computing device 10 then calculates the weight values of the respective articulations based on the reliability of the estimation results of the respective articulations, and computes the similarity between pieces of the skeleton data by using the calculated weight values of the respective articulations. The computing device 10 then determines whether the similarity is equal to or larger than a predetermined threshold. If the similarity is equal to or larger than the predetermined threshold, the computing device 10 determines that authentication has succeeded, and if the similarity is smaller than the predetermined threshold, the computing device 10 determines that authentication has failed. Thus, the computing device 10 can improve accuracy of the authentication processing.

That is, in calculating the similarity score used for authentication, for example, the computing device 10 computes the similarity score while considering the reliability of the estimation result. For example, the computing device 10 can increase reliability of authentication by lowering a contribution degree of an articulation having low reliability to authentication.

### Second Embodiment

The above first embodiment describes the case of calculating the weight values of the respective articulations based on the reliability of the estimation results of the respective articulations output from the skeleton estimation model, but the embodiment is not limited thereto. For example, a moving image may be used at the time of authentication instead of using one static image obtained from a camera, and the weight values of the respective articulations may be calculated based on a degree of variation in the estimated positions of the respective articulations. Thus, the following second embodiment describes a case of calculating the weight values of the respective articulations by using a moving image based on a degree of variation in the estimated positions of the respective articulations. Description about the same configurations and processing as those in the first embodiment will not be repeated.

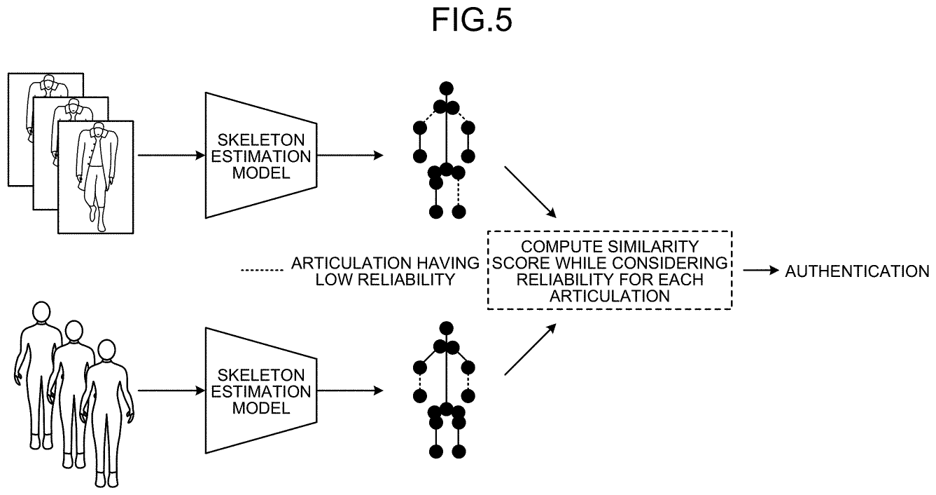

The following describes an outline of authentication processing performed by a computing device 10A according to the second embodiment with reference to FIG. 5. FIG. 5 is a diagram for explaining the outline of the authentication processing performed by the computing device according to the second embodiment. As exemplified in FIG. 5, the acquisition unit 12a of the computing device 10A according to the second embodiment acquires a plurality of pieces of image data from moving image data including a person. The first estimation unit 12b then uses the pieces of image data acquired by the acquisition unit 12a as inputs, and estimates pieces of skeleton data corresponding to the respective pieces of image data by using the skeleton estimation model.

The second estimation unit 12c uses a plurality of pieces of image data stored in advance in the registration information storage unit 13a as inputs, and estimates the pieces of skeleton data corresponding to the respective pieces of image data by using the skeleton estimation model. The calculation unit 12d then calculates the weight values of the respective articulations based on a degree of variation in the estimated positions of the respective articulations in the skeleton data estimated by the first estimation unit 12b and the skeleton data estimated by the second estimation unit 12c.

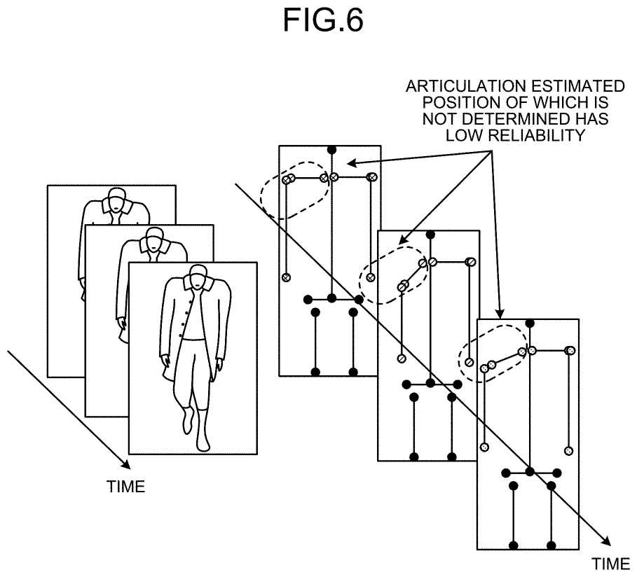

The following describes variation in the estimated positions of the articulations with reference to FIG. 6. FIG. 6 is a diagram for explaining variation in the estimated positions of the articulations. As exemplified in FIG. 6, for example, in a case in which the estimated position of the right shoulder is different among a plurality of images included in the moving image, the calculation unit 12d lowers the reliability of an articulation portion of the right shoulder assuming that there is variation in the estimated positions.

The computing device 10A then computes the similarity score for the two pieces of estimated skeleton data while considering the reliability for each of the articulations. Thereafter, the computing device 10A determines whether the computed similarity is equal to or larger than the predetermined threshold. If the similarity is equal to or larger than the predetermined threshold, the computing device 10A determines that authentication has succeeded, and if the similarity is smaller than the predetermined threshold, the computing device 10A determines that authentication has failed.

Effect of Second Embodiment

The computing device 10A according to the second embodiment acquires the pieces of image data from the moving image data including the person, uses the acquired pieces of image data as inputs, and estimates the pieces of skeleton data corresponding to the respective pieces of image data by using the skeleton estimation model. The computing device 10A uses the pieces of image data stored in advance in the storage unit 13 as inputs, and estimates the pieces of skeleton data corresponding to the respective pieces of image data by using the skeleton estimation model. The computing device 10A then calculates the weight values of the respective articulations based on a degree of variation in the estimated positions of the respective articulations in the respective pieces of estimated skeleton data. Thereafter, the computing device 10A computes the similarity score for two pieces of the estimated skeleton data while considering the reliability for each of the articulations.

In this way, the computing device 10A according to the second embodiment can compute the weight values more adapted to an actual situation by decreasing the weight value of the articulation the estimated position of which is not determined in the moving image and increasing the weight value of the articulation the estimated position of which does not largely vary. As a result, accuracy of the authentication processing can be improved.

System Configuration and Like

The components of the devices illustrated in the drawings are merely conceptual, and it is not required that they are physically configured as illustrated necessarily. That is, specific forms of distribution and integration of the devices are not limited to those illustrated in the drawings. All or part thereof may be functionally or physically distributed/integrated in arbitrary units depending on various loads or usage states. For example, the first estimation unit and the second estimation unit may be integrated with each other. All or optional part of the processing functions performed by the respective devices may be implemented by a CPU or a GPU and computer programs analyzed and executed by the CPU or the GPU, or may be implemented as hardware using wired logic.

Among pieces of the processing described in the present embodiment, all or part of the pieces of processing described to be automatically performed can be manually performed, or all or part of the pieces of processing described to be manually performed can be automatically performed by using a known method. Additionally, the processing procedures, control procedures, specific names, and information including various kinds of data and parameters described herein or illustrated in the drawings can be optionally changed unless otherwise specifically noted.

Computer Program

It is also possible to create a computer program describing the processing performed by the information processing device described in the above embodiment in a computer-executable language. For example, it is possible to create a computer program describing the processing performed by the computing devices 10 and 10A according to the embodiment in a computer-executable language. In this case, the same effect as that of the embodiment described above can be obtained when the computer executes the computer program. Furthermore, such a computer program may be recorded in a computer-readable recording medium, and the computer program recorded in the recording medium may be read and executed by the computer to implement the same processing as that in the embodiment described above.

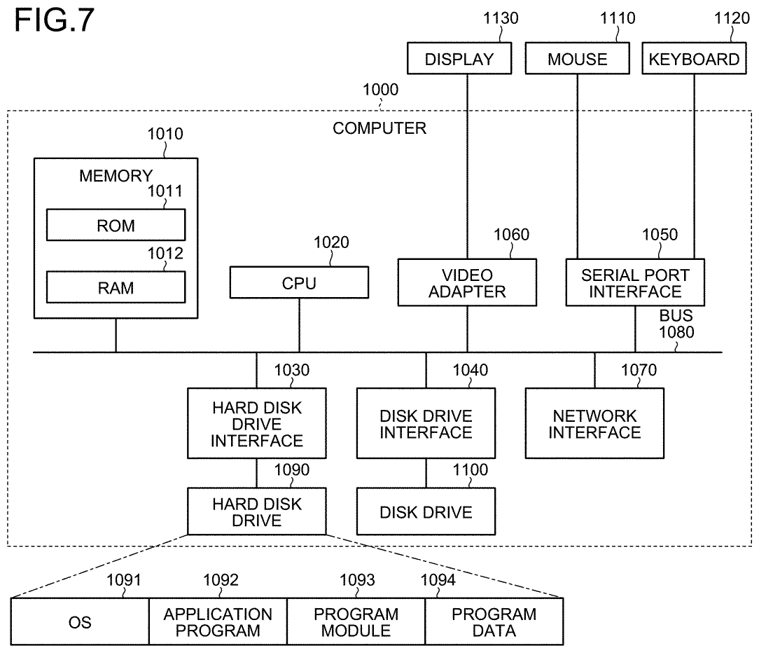

FIG. 7 is a diagram illustrating the computer that executes the computing program. As exemplified in FIG. 7, a computer 1000 includes, for example, a memory 1010, a CPU 1020, a hard disk drive interface 1030, a disk drive interface 1040, a serial port interface 1050, a video adapter 1060, and a network interface 1070, which are connected to each other via a bus 1080.

As exemplified in FIG. 7, the memory 1010 includes a read only memory (ROM) 1011 and a RAM 1012. The ROM 1011 stores, for example, a boot program such as a Basic Input Output System (BIOS). As exemplified in FIG. 7, the hard disk drive interface 1030 is connected to a hard disk drive 1090. As exemplified in FIG. 7, the disk drive interface 1040 is connected to a disk drive 1100. For example, a detachable storage medium such as a magnetic disc or an optical disc is inserted into the disk drive 1100. As exemplified in FIG. 7, the serial port interface 1050 is connected to a mouse 1110 and a keyboard 1120, for example. As exemplified in FIG. 7, the video adapter 1060 is connected to a display 1130, for example.

Herein, as exemplified in FIG. 7, the hard disk drive 1090 stores, for example, an OS 1091, an application program 1092, a program module 1093, and program data 1094. That is, the computer program described above is stored in the hard disk drive 1090, for example, as a program module describing a command executed by the computer 1000.

The various kinds of data described in the above embodiment are stored in the memory 1010 or the hard disk drive 1090, for example, as program data. The CPU 1020 then reads out the program module 1093 or the program data 1094 stored in the memory 1010 or the hard disk drive 1090 into the RAM 1012 as needed, and performs various processing procedures.

The program module 1093 and the program data 1094 related to the computer program are not necessarily stored in the hard disk drive 1090, but may be stored in a detachable storage medium, for example, and may be read out by the CPU 1020 via a disk drive and the like.

Alternatively, the program module 1093 and the program data 1094 related to the computer program may be stored in another computer connected via a network (a local area network (LAN), a wide area network (WAN), and the like), and may be read out by the CPU 1020 via the network interface 1070.

According to the present invention, accuracy of authentication processing can be improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computing device comprising:
processing circuitry configured to:
acquire image data including a person;
first estimate skeleton data by using the image data acquired as an input, and using a skeleton estimation model for estimating the skeleton data related to a skeleton of the person;
calculate weight values of respective articulations based on reliability of estimation results of the respective articulations; and
compute a similarity between the skeleton data estimated and skeleton data estimated from predetermined image data by using the weight values of the respective articulations calculated.

2. The computing device according to claim 1, wherein the processing circuitry is further configured to:
second estimate the skeleton data by using image data stored in advance in a storage as an input, and using the skeleton estimation model,
calculate the weight values of the respective articulations based on the reliability of the estimation results of the respective articulations in the skeleton data estimated, and
compute a similarity between the skeleton data estimated by using the weight values of the respective articulations calculated.

3. The computing device according to claim 2, wherein the processing circuitry is further configured to calculate the weight values of the respective articulations based on the reliability of the estimation results of the respective articulations output from the skeleton estimation model.

4. The computing device according to claim 2, wherein the processing circuitry is further configured to:
acquire a plurality of pieces of image data from moving image data including the person,
first estimate pieces of skeleton data corresponding to the respective pieces of image data by using the pieces of image data acquired as inputs, and using the skeleton estimation model,
second estimate pieces of skeleton data corresponding to respective pieces of image data by using a plurality of pieces of image data stored in advance in the storage as inputs, and using the skeleton estimation model, and
calculate the weight values of the respective articulations based on a degree of variation in estimated positions of the respective articulations in the skeleton data estimated.

5. The computing device according to claim 1, wherein the processing circuitry is further configured to:
determine whether the similarity computed is equal to or larger than a predetermined threshold, determines that authentication has succeeded in a case in which the similarity is equal to or larger than the predetermined threshold, and
determine that authentication has failed in a case in which the similarity is smaller than the predetermined threshold.

6. A computing method comprising:
acquiring image data including a person;
estimating skeleton data by using the image data acquired at the acquiring as an input, and using a skeleton estimation model for estimating the skeleton data related to a skeleton of the person;
calculating weight values of respective articulations based on reliability of estimation results of the respective articulations; and
computing a similarity between the skeleton data estimated at the estimating and skeleton data estimated from predetermined image data by using the weight values of the respective articulations calculated at the calculating.

7. A non-transitory computer-readable recording medium storing therein a computing program that causes a computer to execute a process comprising:
acquiring image data including a person;
estimating skeleton data by using the image data acquired at the acquiring as an input, and using a skeleton estimation model for estimating the skeleton data related to a skeleton of the person;
calculating weight values of respective articulations based on reliability of estimation results of the respective articulations; and
computing a similarity between the skeleton data estimated at the estimating and skeleton data estimated from predetermined image data by using the weight values of the respective articulations calculated at the calculating.
